(19) United States
(12) Patent Application Publication
(10) Pub. No.: US 2003/0176216 A1
(43) Pub. Date: Sep. 18, 2003

(54) Universal bonus trigger for a gaming machine

(76) Inventor: Mike Storey, Moncton, CA (US)

Correspondence Address: Oppenheimer Wolff & Donnelly LLP, Suite 3300, 45 South Seventh Street, Minneapolis, MN, 55402-1609, US

(21) Appl. No.: 10/099,228

(22) Filed: Mar. 13, 2002

(51) Int. Cl. A63F 13/00

(52) U.S. Cl. 463/25

(57) ABSTRACT

A gaming machine of the present invention comprises a processor for controlling game play in a basic mode and a bonus mode. The processor operating in the basic mode selects a base game outcome from among a plurality of possible base game outcomes, the possible base game outcomes including a start-bonus outcome the selection of which causes the processor to shift operation from the basic mode to the bonus mode. The processor operating in the bonus mode selects a bonus game from among a plurality of possible bonus games operable in the bonus mode and awards credits in the selected bonus game. The start-bonus outcome is a single event that may lead to the selection of any of the possible bonus games operable in the bonus mode.

### BACKGROUND OF THE INVENTION

1. Field of the Invention

This invention relates generally to a slot machine, and more particularly to a slot machine that operates in a basic mode in which a base game is played and in a bonus mode in which a bonus game is played before returning to the basic mode. The bonus mode is initiated in response to the occurrence of a special start-bonus outcome in the basic mode.

2. Description of the Related Art

A standard spinning reel gaming machine provides the opportunity to participate in a game of chance where a player wagers on the outcome of each game in the hopes of receiving a winning combination on the slot reels. As is well known to those skilled in the art, a simplified example of a reel game on which the player wagers has multiple reels that rotate and have at least one horizontal payline on the face of the machine. A single gaming machine may also have multiple paylines, and some gaming machines have paylines that are diagonal, V-shaped, or a variety of other configurations. To determine the game outcome, the reels stop spinning at random positions and the symbols present at the payline are examined.

While the earliest slot machines generally included reel strips attached around the circumference of a mechanical reel, the reel strip containing a plurality of reel elements, it is now common to simulate such reels and reel elements digitally through a video display. A player viewing the video display will observe reel strips pass by the payline as the simulation begins. As the video display shows each reel coming to a stop, reel elements are displayed aligned with the payline or paylines.

When the simulated reels come to rest, the game outcome is determined by the arrangement of reel elements aligned with the payline. A winning combination outcome is generally the result of the same reel element from each reel, or from a certain minimum number of reels, aligning on the same payline. For instance, when the three reels of a gaming machine with reel elements of fruit stop spinning, three cherries may stop on the payline. This arrangement constitutes a winning combination of three in a row.

To determine the prize awarded for each type of winning combination, the gaming machine refers to a paytable. The paytable is a chart of numbers denoting the various winning combinations and their corresponding prizes. For instance, some gaming machines define as winning combinations any three reel elements aligned on the same payline. For example:

| Element | Pay |
|---|---|
| 3 Sevens | 100 |
| 3 Lemons | 20 |
| 3 Cherries | 10 |

Other gaming machines include as winning combinations two aligned reel elements or even a single reel element.

The determination of which reel elements are aligned with paylines when they stop spinning is derived from a random number generator, which provides seemingly random results. The game and its related paytable are then designed to ensure that certain game outcomes occur with a desired frequency. Accordingly, the probability of receiving any of the selected winning combinations is predetermined by configuring the reel elements appropriately. The paytable is similarly configured to ensure that the game has a desired payout. Often, such payout is governed by public regulations and is called the winning percentage. Specifically, the winning percentage or payout denotes the statistical percentage of the player's wager that will be returned to the players (i.e. paid out in winnings) based upon probability data.

A “bonus game” is a widely used term that describes an additional game that is layered on top of a base game. This is one way of providing additional excitement to the player. Typically, when a certain configuration of reel elements or symbols are displayed in the base game, the player is given the opportunity to play the bonus game. Often, the bonus game will include guaranteed winnings or increased winning amounts, making the game much more exciting for the player.

Despite the name “bonus game,” the play of the game does not actually pay a bonus back to the player over and above the gaming machine's winning percentage. Instead, a portion of a gaming machine's winning percentage is withheld and not returned to players during play of the base game. Such withholding or removal is accomplished by appropriately configuring the reel elements or altering the paytable. For example, the winning percentage could be configured as follows:

| | Win % |
|---|---|
| Base Game | 70% |
| Bonus Game | 20% |
| Total | 90% |

Accordingly, the gaming machine's overall winning percentage has not been altered but an added element of excitement has been included. Bonus games can take many forms, but they do have a commonalty; the bonus game is another way of redistributing a portion of the winning percentage.

The reason for using a bonus game or a secondary game is the player anticipation created by the variety and volatility. Firstly, players may bore after playing the same type of game repeatedly, and if that monotony is occasionally broken up with different types of games, then the gaming machine is more interesting for the player. Bonus games can also be more volatile, delivering different types of wins to players and offering players prizes different than those accommodated for in the base game's paytable.

Bonus games can take on a wide variety of formats. For instance, one type of bonus game is a pick-a-prize game. During play, a player has four possible selections, each associated with a different prize value, and the player is prompted to select one. The player has a one in four chance of receiving each prize value. Accordingly, where the four prize values are 10, 20, 30, and 40 prize units, the average win in the bonus game is 25 prize units, the mathematical average of all four numbers.

PICK ONE

| ? | ? |
|---|---|
| ? | ? |
| 40 | ? |
| ? | ? |
| 40 | 30 |
| 20 | 10 |

A gaming machine that operates in a bonus game and has a 90% total payout, 70% of which is awarded during the base game, must have a bonus game payout of 20%. Consequently, the bonus game is carefully designed to meet this bonus payout percentage. Obviously, this is necessary to insure the continued economic viability of the gaming machine and meet regulatory requirements.

To shift a player from the base game to the bonus game, there is typically a predetermined bonus trigger. It is common for the bonus trigger to be a specific condition or conditions in the base game. In the same way the frequency of receiving winning combinations can be configured, so too can the base game be designed to control the frequency of receiving the bonus trigger. Accordingly, a bonus game payout can be designed to constitute any desired fraction of the total payout. One example of a bonus trigger is an element on one of the reels labeled “bonus.” Another example is a specified combination of elements, stopping on the payline. When the element or elements stop on the payline, the game play is shifted from the base game into the bonus game.

In addition to a variety of bonus triggers, different bonus games exist. These bonus games include matching any two symbols on different reels (“Match 'em bonuses”), free or specially structured spins (“spin bonuses”), progressively increasing pots, which grow until they are won (“progressive bonuses”), and many more games.

For existing gaming machines with multiple bonus games, each unique bonus game has a bonus trigger that initiates the corresponding bonus game. In existing gaming machines with multiple triggers or conditions that shift play from a base game to a bonus game, each trigger or condition leads only to a single corresponding bonus game. Thus, the probability of the gaming machine shifting to a specific bonus game is determined by base game play. Further, where the trigger is visible to the player, such as a “bonus” element on a simulated reel, the player will know to which of the bonus games the gaming machine will shift.

One of the competitive factors that may distinguish one gaming machine from another to potential players is the ability to generate enthusiasm and create a sense expectancy or suspense. Gaming machine designers may compete at attracting players by creating more excitement or anticipation through their machines. One way this may be accomplished is by offering a variety of bonus games in an interesting manner. Accordingly, there is a need to offer gaming machines with an innovative presentation of a variety of bonus games, the gaming machines initiating the bonus games in a manner that generates player excitement and anticipation.

### SUMMARY OF THE INVENTION

In a gaming device which allows a number of bonus games to be played in response to a common bonus trigger, players are offered a new and exciting alternative to existing gaming machines. Therefore, it is an object of the present invention to provide a gaming machine with such a universal bonus trigger.

The universal trigger of the present invention may be selected in the base game and is common or universal for multiple bonus games. Upon the occurrence of the universal trigger, the gaming machine shifts into the bonus mode and selects one of a plurality of bonus games to be played. The gaming machine's total prize payout or winning percentage is derived from the sum of two separate payout numbers: 1) the base game payout, and 2) the bonus mode payout. The bonus mode payout is the mathematical average of all the individual bonus game payouts, where each individual bonus game payout is weighted in proportion to the frequency with which it is played. Alternatively, the bonus mode payout may be a weighted average depending on how the bonus game selection is accomplished.

In order to attain the above objective, a gaming machine of the present invention comprises a processor for controlling game play in a basic mode and a bonus mode. While operating in the basic mode, the gaming machine operates a game under straightforward rules allowing the player to play a predetermined base game. The base game has an associated base game payout table which reflects that base game's payout percentage

As an example, a typical 9-payline/5-reel game may be played as the base game wherein the player is awarded prizes for predetermined combinations. Upon the occurrence of such a predetermined combination of elements, which appears in the base game payout table as a winning combination, credits are awarded according to the base game paytable.

Upon the occurrence of a predetermined trigger event, the universal bonus trigger, the processor shifts to the bonus mode. While in the bonus mode, the processor selects a bonus game from among a plurality of possible bonus games. Each bonus game includes a set of rules or steps which are followed, along with a corresponding paytable, which reflects that bonus game's payout percentage. In the bonus mode, credits are awarded according to the pay table of the selected bonus game.

Based upon the configuration of the games, the gaming machine has a predetermined total payout percentage, which is based on the payout percentages of the basic mode and the bonus mode. Because the base game is the only game played in the basic mode, the payout percentage of the basic mode is merely the predetermined base game payout percentage. The base game payout table reflects this percentage. The bonus mode payout percentage, however, is based on the payout percentages of those bonus games and the frequency with which each is played. For instance, a gaming machine with three bonus games having payout percentages 10%, 20%, and 30%, where each bonus game has the probability of being selected with equal frequency, has bonus mode payout percentage of 20%.

When the universal bonus trigger shifts game play to the bonus mode, the gaming machine then alters its operation to play one of the bonus games. Specifically, upon the occurrence of the universal trigger, the processor shifts from the basic mode to a bonus mode. In the bonus mode any one of a plurality of bonus games are potentially played. Each bonus game is operated independent from one another such that the prize awarded in one bonus game does not affect the prize awarded in a different bonus game.

In one embodiment, the gaming machine may play each of the bonus games with equal frequency. To accomplish this, upon entering the bonus mode, the gaming machine may randomly select a bonus game from among the possible bonus games without regard to any order but at the same time ensuring no bonus game is repeated until all have been selected. In this way, all bonus games are selected once before being selected a second time. The gaming machine thereby cycles through the bonus games and then repeats its cycle. However, due to the random nature of selection, each cycle may differ from the cycle preceding it. The actual bonus game to be played is unknown to the player until it appears on the display. By operating in this mode, the player is enticed with the anticipation of discovering which bonus game will appear next and can look forward to the excitement of that discovery.

Alternatively, the gaming machine may cycle through the bonus games in a linear manner such that the bonus game selection order is predetermined and is identical for each cycle. In this embodiment, no bonus game will be repeated in a single cycle. By operating in this mode, the player can anticipate which bonus game is upcoming and look forward to the excitement of playing that bonus game.

In yet another mode, the gaming machine selects a bonus game from among the possible bonus games at random. Accordingly, every time the gaming machine enters the bonus mode and selects a bonus game, each bonus game has a predetermined probability of being selected. The gaming machine thereby selects bonus games randomly and does not maintain a particular cycle of bonus games or ensure bonus games are not repeated prior to the selection of other bonus games. By operating in this mode, the player is enticed with the anticipation of discovering which bonus game will appear next and has no knowledge of the likelihood of any given bonus game appearing, thereby increasing the player's suspense.

An example of one embodiment provides for a gaming machine that has a bonus mode that includes three different bonus games. The occurrence of the universal trigger as the base game outcome causes the gaming machine processor to shift from base game play to any of the three bonus games. The probability of obtaining the universal trigger as the base game outcome is designed to be once for every 80 games played. Further, each of the three bonus games has an equal probability of occurring once the universal trigger has been generated. Once in the bonus mode, each of the three different bonus games has a unique bonus game payout percentage, but their mathematical average is equal to the overall bonus mode payout percentage.

| | Game Payout |
|---|---|
| Bonus Game | Percentage |
| Level 1: | 10% Distribution |
| Level 2: | 20% Distribution |
| Level 3: | 30% Distribution |
| Overall Bonus Mode | 20% Distribution |
| Payout Percentage | |

As a more detailed example of one embodiment of the present invention, consider a 3-reel, one payline game with three base game elements: seven, lemon, and cherry. A single bonus trigger, called “bonus” is configured to potentially appear on the middle reel. The overall machine payout percentage is 90%, with 70% being allocated to the base game, thereby leaving 20% for the bonus mode payout percentage. The three bonus games, labeled Level 1, Level 2 and Level 3, have a bonus game payout percentage of 10%, 20% and 30% respectively. Further, the game is configured such that each bonus has an equal probability of occurring. Thus, the mathematical average of all the bonus game payout percentages is equal to the bonus mode payout percentage, 20%.

### BRIEF DESCRIPTION OF THE DRAWINGS

FIG. 1 is a simplified illustration of a spinning reel gaming machine with video display on which the present invention may be implemented.

FIG. 2 is a block diagram of the gaming machine architecture.

FIG. 3 is an illustration of three virtual reel strips which may be displayed on the video display of the gaming machine of FIG. 1 to implement a standard gaming machine game.

FIG. 4 is a paytable for various symbol combinations which may occur in a base game using the virtual reel strips of FIG. 3.

FIG. 5 is flow chart which shows the steps used in the basic configuration of the gaming machine with a universal bonus trigger.

FIG. 6 is a block diagram illustrating the relationship of various payout percentages.

FIG. 7 is flow chart which shows the steps used in a configuration of the gaming machine with two universal bonus triggers.

### DETAILED DESCRIPTION OF THE PREFERRED EMBODIMENT

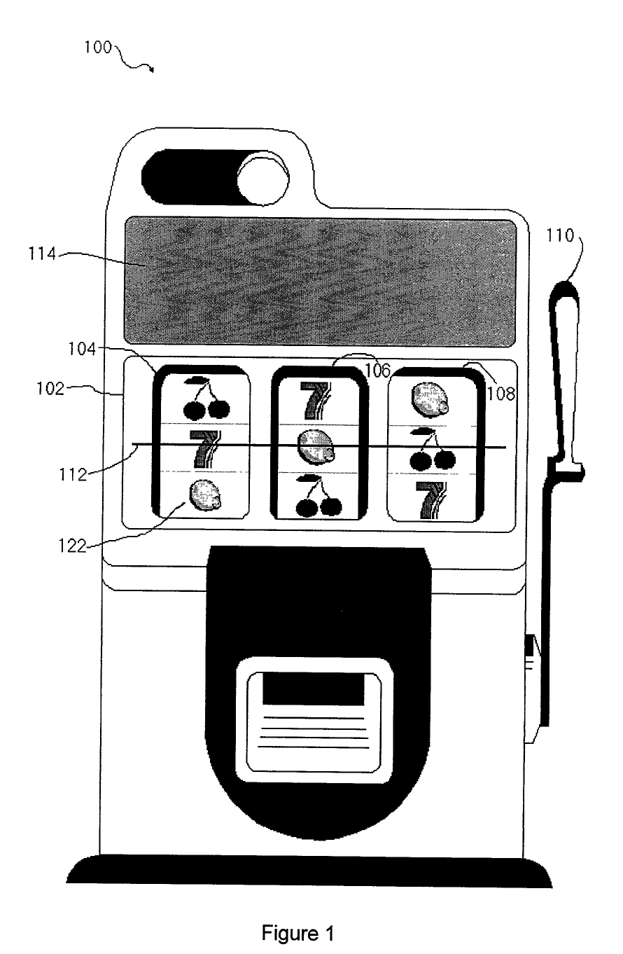

Turning now to the drawings and referring initially to FIG. 1, there is shown an example gaming machine 100 (e.g., slot machine) on which the present invention may be implemented. Gaming machine 100 is operable in a basic mode to play a base game and in a bonus mode to play bonus games. Gaming machine 100 includes a display 102 where a player may observe spinning virtual reels, 104, 106, and 108. Though virtual reels 104, 106, 108 are simulated by gaming machine 100 and are not physical reels, each includes a variety of simulated reel elements 122. Reel elements, 122, appear to pass under a payline 112 as they spin and appear to stop moving as virtual reels 104, 106, and 108 stop spinning. Gaming machine 100 further includes a display 114 for displaying various graphics associated with game play. The basic game may be implemented on virtual reels 104, 106, 108, while the bonus games may be implemented on display 114. Alternatively, display 114 may simply provide space for promotional graphics. Lever 110 may be pulled to initiate a base game, however, it is common for the same function to be accomplished by a switch or button as described below.

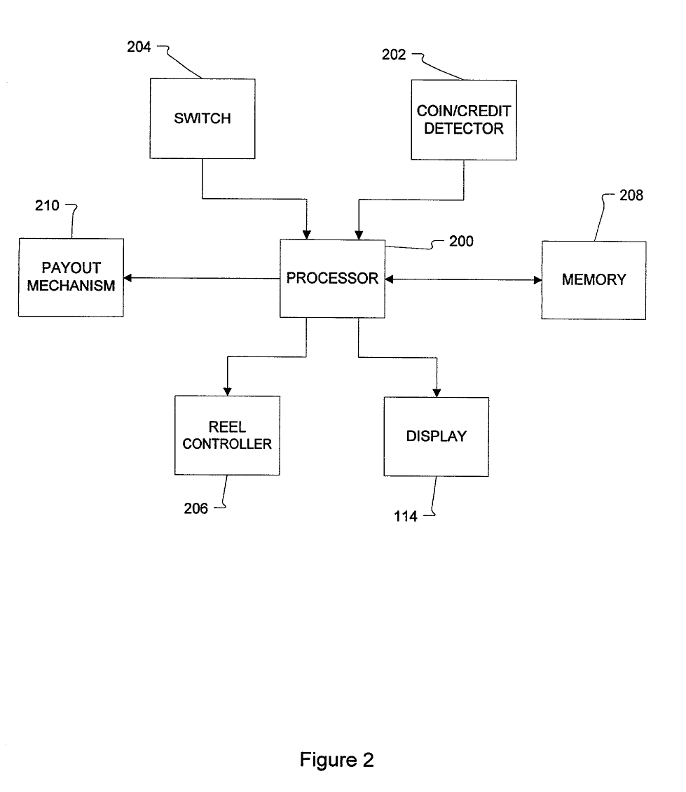

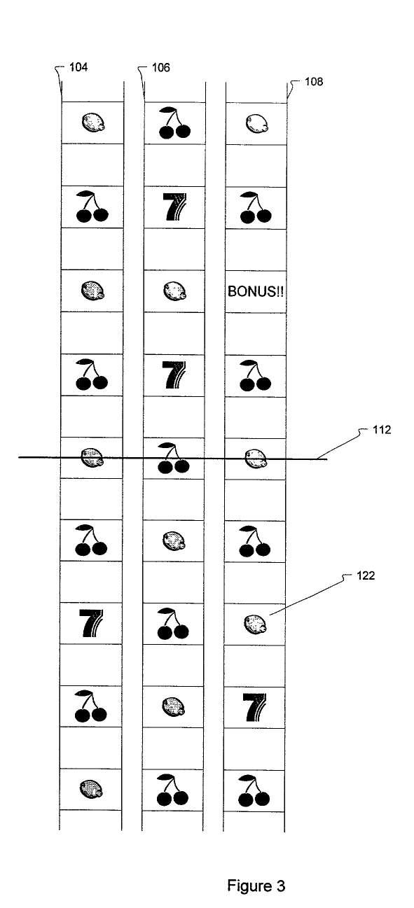

FIG. 2 is a block diagram of a gaming machine architecture suitable for operating gaming machine 100 of FIG. 1. As shown in FIG. 2, a coin/credit detector 202 signals a processor 200 when a player has inserted a number of coins or played a number of credits. Subsequently, in response to the player activating a switch 204 (e.g., by pulling lever 110 or pushing a button), processor 200, operating in the basic mode, initiates base game play by setting virtual reels 104, 106, 108 in motion, randomly selects stop positions for virtual reels 104, 106, 108 and, causes a reel controller 206 to stop the reels 104, 106, 108 at the selected stop positions (i.e., appropriately display the stopped reels). Once the reels are stopped, the combination of reel elements 122 aligned under payline 112 define the base game outcome. Thereby, a base game outcome is generated from a plurality of possible base game outcomes. FIG. 3 shows a set of reel strips for use with a gaming machine of the type shown in FIG. 1. The probability of generating a specific base game outcome is determined by the configuration and number of reel elements 122 on virtual reels, 104, 106, and 108, as shown in FIG. 1.

Though the embodiment described monitors the combination of only those reel elements 122 which are aligned with the single payline 112 to determine the base game outcome, the present invention may use a variety of other payline configurations to define the base game outcome. For example, the gaming machine 100 may also include an upper payline (where the combination of reel elements consisting of the upper reel elements on each reel comprises the game outcome), lower payline (where the combination of reel elements consisting of the lower reel elements on each reel comprises the game outcome), angled paylines (where the combination of reel elements consisting of the lower, center and upper reel elements, respectively, or upper, center and lower reel elements, respectively, on the three reels comprises the game outcome) or diamond-shaped paylines (where the combination of reel elements consisting of the center reel elements on the first and third reels and either the upper or lower reel elements on the second reel comprises the game outcome).

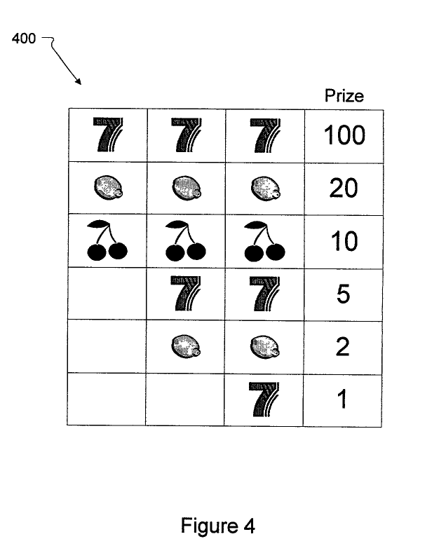

Returning to FIG. 2, memory 208 contains control software, operational instructions, and data associated with gaming machine 100. Accordingly, a payout mechanism 210 in FIG. 2 is operable in response to instructions from processor 200 to award credits to the player in response to certain game outcomes stored in memory 208. The various winning combinations are defined by a paytable 400, shown in FIG. 4. For instance, the paytable in FIG. 4 identifies the various winning combinations and their corresponding credits: “SEVEN, SEVEN, SEVEN” awards 100 credits; “LEMON, LEMON, LEMON” awards 20 credits; “CHERRY, CHERRY, CHERRY” awards 10 credits; “Blank, SEVEN, SEVEN” awards 5 credits; “Blank, LEMON, LEMON” awards 2 credits; and “Blank, Blank, SEVEN” awards 1 credit.

The data stored in memory 208, shown in FIG. 2, further defines the total payout percentage, basic mode payout percentage, bonus mode payout percentage, and bonus game payout percentages for gaming machine 100, all of which are predetermined values. A payout percentage is the percentage of a player's wager that is returned through awarded credits. This data is contained in a paytable 400, shown in FIG. 4, for each payout percentage. For instance, the basic mode payout percentage is the percentage of the player's wager that is returned on average play during basic mode play as awarded credits.

A paytable 400 is stored in memory 208, which, in part, defines the basic payout percentage based on the number and configuration of reel elements 122. Gaming machine 100 determines the correct number of credits to award by analyzing the reel elements that are aligned with payline 112, and determining if the combination of reel elements is contained on paytable 400. If the combination is defined on paytable 400, then gaming machine 100 awards the corresponding number of credits.

As described above, the basic mode payout percentage is the percentage of the player's wager that is returned on average play in the basic mode. Because there is a single base game that can be played in the basic mode, the basic mode payout percentage is merely the payout percentage of that base game. If the base game has a payout percentage of 70%, then the basic mode payout percentage is also 70%. This payout percentage is “controlled” by the way the base game is designed.

Similarly, where a bonus game is included the bonus mode payout percentage is the percentage of the player's wager that is returned on average play in the bonus mode. As described in further detail below, the game of the present invention will include a bonus mode that includes multiple bonus games. The bonus mode payout percentage can be determined by the mathematical average of all bonus game payout percentages, weighted by the frequency with which each bonus game is played. For instance, if the bonus mode has a payout percentage of 20%, then upon substantial play, 20% of players' wagers are returned as awarded credits while the gaming machine is operating in the bonus mode.

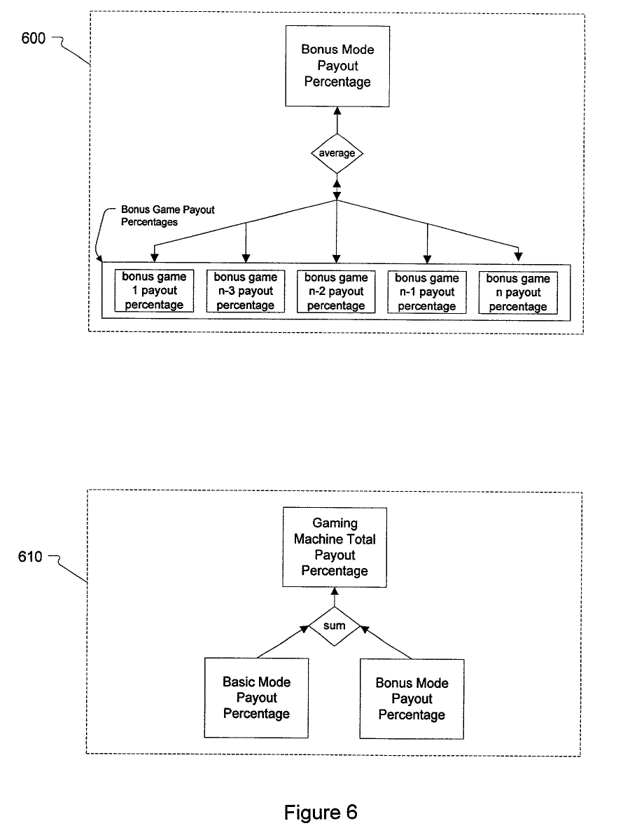

The relationships of these various payout percentages are illustrated in FIG. 6. Where the bonus games are selected with equal frequency, the bonus mode payout percentage is the average of the individual bonus game payout percentages, as shown in relationship 600 on FIG. 6. For instance, where there are three bonus games with bonus game payout percentages of 10%, 20%, and 30%, the bonus mode payout percentage is 20%, the mathematical average of the bonus game payout percentages. Importantly, each bonus game has an associated bonus game payout percentage, and the bonus games operate independently from one another.

The total payout percentage is the sum of the basic mode payout percentage and the bonus mode payout percentage, shown in relationship 610. For instance, if the basic mode a payout percentage is 70% and the bonus mode payout percentage is 20%, then the total payout percentage is 90%.

Referring back to the operation of the present game, after gaming machine 100 awards the credits to the player in the basic mode in response to a winning combination as defined by paytable 400, processor 200 continues operating in the basic mode. Alternatively, where the base game outcome is not a winning combination and is also not the universal trigger outcome, no prize is awarded to the player and processor 200 continues operating in the basic mode.

In addition to the potential winning combinations possible in the base game, the base game outcome may be a universal trigger or “start-bonus” outcome. This start bonus outcome can take many forms depending upon the desired overall configuration of gaming machine 100. For example, there may be a “start-bonus” reel element, such as the reel element labeled “BONUS!!” on reel 108 in FIG. 3. The start-bonus outcome may occur when virtual reel 108 is stopped such that the “BONUS!!” element is aligned with payline 112. Alternatively, there may be a plurality of reel elements 122 that are labeled “BONUS!!”, and the start-bonus outcome is selected when a predetermined combination of the “BONUS!!” elements stop on a payline 112. For instance, the start-bonus outcome could comprise: “BONUS, BONUS, BONUS”, “BONUS, LEMON, BONUS”, “LEMON, BONUS, LEMON”, or any other predetermined combination of reel elements. When the base game outcome is the start-bonus outcome, processor 200 shifts from operating in the basic mode to operating in the bonus mode.

Upon generating the start-bonus outcome and shifting to the bonus mode, processor 200, operating in the bonus mode selects a bonus game from among a plurality of possible bonus games operable in the bonus mode. Once a bonus game has been selected, processor 200 presents the selected bonus game for the player on video display 114. Importantly, the start-bonus outcome is a single event or outcome that may lead to any of the available bonus games.

Under control of either the player or the processor 200, the bonus game outcome is selected. Upon completion of the bonus game, processor 200 awards credits to the player. Though a variety of different bonus games may be selected, each has an associated bonus game payout percentage. The winnings awarded to the player are based solely on the selected bonus game payout percentage. Once processor 200 awards credits to the player, processor 200 returns game play to the basic mode. Each bonus game is operated independently from the others, such that a large award in one bonus game does not affect the predetermined payout percentage of another bonus game.

For example, the selected bonus game might have a bonus game payout percentage of 30%. During play of that bonus game the player could be offered three possible selections, each associated with a different prize value and each having an equal likelihood of being selected. Obviously, larger or smaller prize values could be involved, but the average prize value of these selections must correspond to a 30% payout percentage.

In one embodiment, when processor 200 shifts from the basic mode to the bonus mode and selects a bonus game from among a plurality of possible bonus games, the processor selects each of the bonus games with equal frequency. Processor 200 may either select from the possible games at random or ensure that all bonus games are selected once before being selected a second time. In the latter approach, gaming machine 100 cycles through all bonus games before beginning a new cycle. When cycling through different bonus games, processor 200 may cycle through the bonus games in a linear manner such that the bonus game selection order is predetermined and is identical for each cycle. In this approach, the user may begin to learn the order of bonus games and anticipate the upcoming bonus game. Where the bonus games have differing payout percentages, and the player is aware of that fact, the player may have increased anticipation for an upcoming bonus game with a higher payout percentage.

Alternatively, processor 200 may cycle through the bonus games in a random manner such that the bonus game selection order is not known to the player and the selected bonus game is not known until it is selected. By operating in this manner, each cycle may differ from the cycle preceding it, thereby offering the player variety, and the player's suspense may be increased by requiring the player to wait to learn which bonus game is selected until the universal bonus trigger occurs and a bonus game is selected.

In yet another embodiment of the invention, processor 200 selects a bonus game from among the possible bonus games such that the probability of selecting each bonus game is different. For instance, there may be three bonus games, Bonus Game 1, Bonus Game 2, and Bonus Game 3, with the associated probabilities of being selected 10%, 45%, and 45%. By operating in this manner, Bonus Game 1 is selected less frequently, perhaps to account for a higher payout percentage, thereby providing the player with the added anticipation and excitement of waiting for the occurrence of Bonus Game 1.

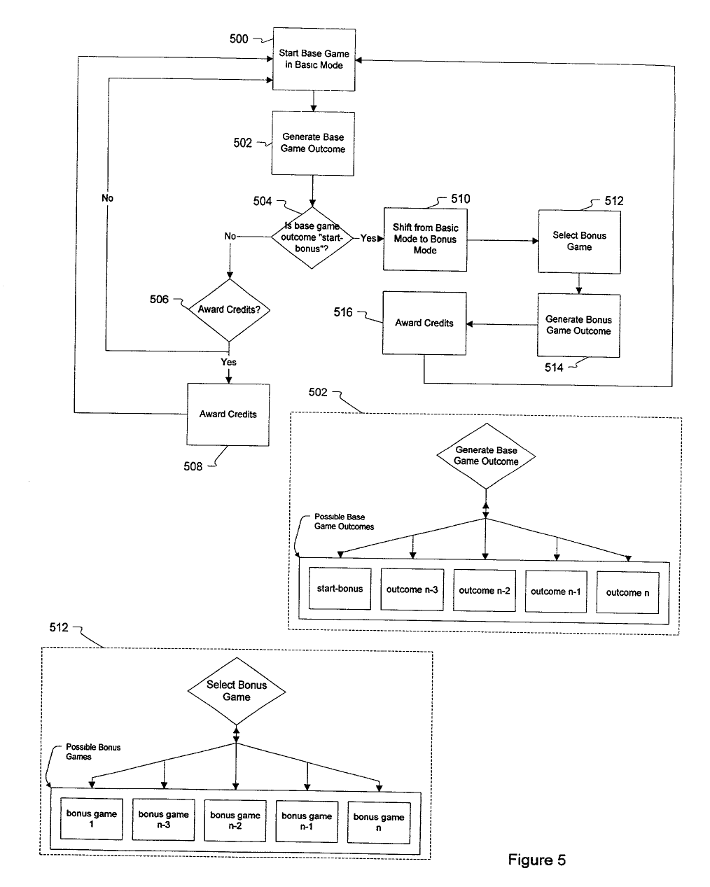

FIG. 5 is a flow chart illustrating operation of one embodiment of the present invention. This method of the present invention as practiced on gaming machine 100 with a universal bonus trigger begins by starting the base game in the basic mode, step 500. In step 500, gaming machine 100 operating under control of the processor 200 begins operating a base game in the basic mode in response to receiving a signal from coin/credit detector 202 indicating that a player inserted coins or played a number of credits.

In step 502, under control of either the player or processor 200, a base game outcome is generated from among a plurality of possible base game outcomes. In step 504, processor 200 determines whether the base game outcome is the start-bonus outcome. If the base game outcome selected is not the start-bonus outcome, processor 200 determines whether the base game outcome requires credits to be awarded (step 506), such as a base game outcome of a winning combination. If the base game outcome requires credits to be awarded, processor 200 awards credits through the payout mechanism 210 (step 508) and continues operating in the basic mode. Otherwise, the processor 200 continues operating in the basic mode.

If the base game outcome selected is the start-bonus outcome, processor 200 shifts its operation from the basic mode to the bonus mode (step 510). Upon entering the bonus mode, processor 200 selects a bonus game from among a plurality of possible bonus games operable in the bonus mode (step 512). In step 514, under control of the processor 200 or the player, the bonus game outcome is selected from among a plurality of possible bonus game outcomes. In step 516, processor 200 awards credits in the selected bonus game.

Each of the plurality of possible bonus games operable in the bonus mode has an associated bonus game payout percentage. Accordingly, awarding credits in the bonus mode, step 516, is based on a bonus game payout percentage of the selected bonus game. For instance, there may be a bonus mode with three bonus games, Bonus Games 1, Bonus Game 2, and Bonus Game 3, with bonus game payout percentages of 10%, 20%, and 30% respectively. On average play, the credits awarded when Bonus Game 1 is selected correspond to a 10% payout percentage. If the bonus games are selected with equal frequency, the bonus mode payout percentage is 20%.

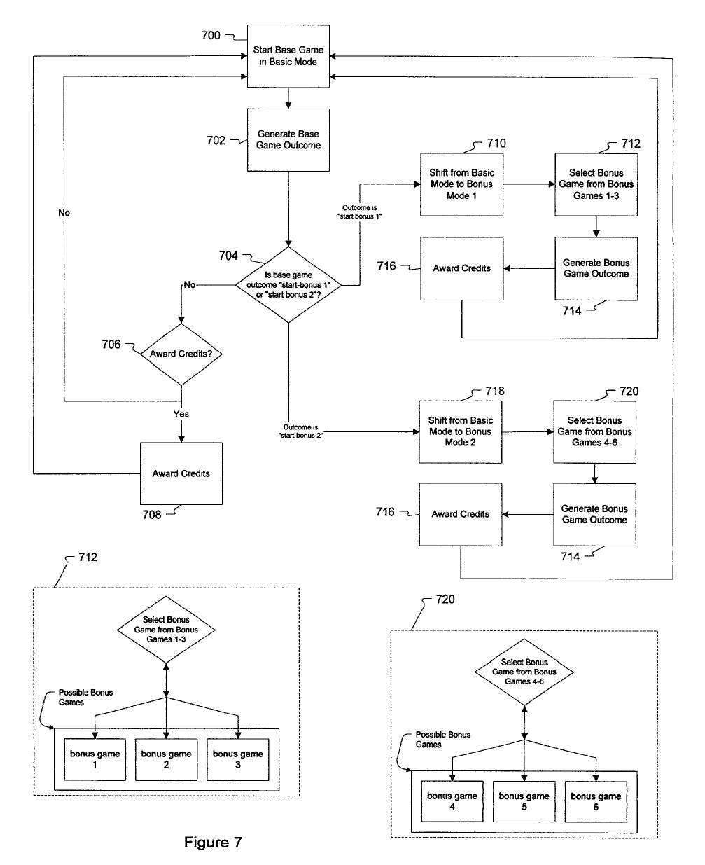

When discussed above, a single trigger event or universal trigger causes the processor 200 to shift to a bonus mode that includes multiple bonus games. It is envisioned that the present invention may also be implemented such that there are multiple trigger events that each cause the processor 200 to shift from the basic mode to a unique bonus mode. Each unique bonus mode includes a unique set of bonus games. For instance, FIG. 7 is a flow chart illustrating the operation of an embodiment of the present invention where gaming machine 100 has two universal triggers, each associated with a distinct set of bonus games.

This method of the present invention begins similarly to the method previously described, starting the base game in the basic mode, step 700, and generating a base game outcome from among a plurality of possible base game outcomes, step 702. The plurality of possible base game outcomes include two universal triggers, “start bonus 1” and “start bonus 2”. In step 704, processor 200 determines whether the base game outcome is one of the start-bonus outcomes. If not, processor 200 determines whether the base game outcome requires credits to be awarded (step 706). If the base game outcome requires credits to be awarded, processor 200 awards credits (step 708). Otherwise, the processor 200 continues operating in the basic mode.

If the base game outcome selected is the “start bonus 1” outcome, processor 200 shifts its operation from the basic mode to bonus mode 1 (step 710). Upon entering bonus mode 1, processor 200 selects a bonus game from a distinct set of possible bonus games operable in bonus mode 1 (step 712). In this particular example, the bonus games operable in bonus mode 1 are bonus game 1, bonus game 2, and bonus game 3. In step 714, under control of the processor 200 or the player, the bonus game outcome is selected from among a plurality of possible bonus game outcomes. In step 716, processor 200 awards credits in the selected bonus game.

On the other hand, if the base game outcome generated in step 702 is the “start bonus 2” outcome, processor 200 shifts its operation from the basic mode to bonus mode 2 (step 718). Upon entering bonus mode 2, processor 200 selects a bonus game from a distinct set of possible bonus games operable in bonus mode 2 (step 720). In this particular example, the bonus games operable in bonus mode 2 are bonus game 4, bonus game 5, and bonus game 6. Next, as in bonus mode 1, the bonus game outcome is selected (step 714) and, processor 200 awards credits in the selected bonus game (step 716).

In this example, bonus games 1-3 are distinct from bonus games 4-6. Further, the processor operating in bonus mode 1 or bonus mode 2 may select bonus games either linearly or randomly as described above, but the selection approach need not be the same for both bonus modes. In this example, the total payout percentage of gaming machine 100 is the sum of the basic mode payout percentage, the bonus mode 1 payout percentage, and the bonus mode 2 payout percentage.

When discussed above, either the base game or the bonus game will be generally understood to include any game of chance. While the spinning reel slot machine has been discussed above, other games such as random selection or additional reel games may be used to implement the present invention as well.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention which is set forth in the following claims.

What is claimed is:

1. A gaming machine comprising:
a processor for controlling game play in a basic mode and a first bonus mode;
the processor operating in the basic mode to generate a base game outcome in a base game, the possible base game outcomes including a first start-bonus outcome the occurrence of which causes the processor to shift from operating in the basic mode to operating in the first bonus mode;
the processor operating in the first bonus mode to select a first bonus game from among a first plurality of possible bonus games; and
the processor operating in the first bonus mode to generate a bonus game outcome in the first bonus game, the possible bonus game outcomes including an award-credit outcome the occurrence of which causes the processor to award credits in the first bonus game.

2. The gaming machine of claim 1 wherein:
each of the first plurality of possible bonus games has an associated bonus game paytable; and
the processor operating in the first bonus mode awards credits in the first bonus game based on the associated bonus game paytable of the first bonus game.

3. The gaming machine of claim 1 wherein the processor selects each of the first plurality of possible bonus games with equal frequency.

4. The gaming machine of claim 1 wherein the processor selects each of the first plurality of possible bonus games a second time only after all of the first plurality of possible bonus games have been selected once.

5. The gaming machine of claim 4 wherein the processor selects the first bonus game randomly.

6. The gaming machine of claim 4 wherein the processor selects the first bonus game linearly, such that each of the first plurality of possible bonus games is selected in a predetermined order.

7. The gaming machine of claim 1 wherein:
the processor further controls game play in a second bonus mode;
the possible base game outcomes further include a second start-bonus outcome the occurrence of which causes the processor to shift from operating in the basic mode to operating in the second bonus mode;
the processor operates in the second bonus mode to select a second bonus game from among a second plurality of possible bonus games; and
the processor operates in the second bonus mode to generate the bonus game outcome in the second bonus game.

8. The gaming machine of claim 7 wherein the processor selects each of the second plurality of possible bonus games a second time only after all of the second plurality of possible bonus games have been selected once.

9. The gaming machine of claim 8 wherein the processor selects the second bonus game randomly.

10. The gaming machine of claim 8 wherein the processor selects the second bonus game linearly, such that each of the second plurality of possible bonus games is selected in a predetermined order.

11. The gaming machine of claim 1 further comprising a display screen for displaying the base game outcome, the bonus game outcome, and winning credits awarded by the processor.

12. The gaming machine of claim 11 further comprising a plurality of input buttons allowing interaction with the player during the play of both the base game and the bonus game.

13. A method of operating a gaming machine under control of a processor operable in a basic mode and a first bonus mode, the method comprising the steps of:
generating in the basic mode under control of the processor a base game outcome in a base game, the possible base game outcomes including a first start-bonus outcome;
shifting the processor from operating in the basic mode to operating in the first bonus mode in response to the occurrence of the first start-bonus outcome, otherwise, continuing operation of the processor in the basic mode;
selecting in the first bonus mode under control of the processor a first bonus game from among a first plurality of possible bonus games;
generating in the first bonus mode under control of the processor a bonus game outcome in the first bonus game, the possible bonus game outcomes including an award-credit outcome; and
awarding credits in the first bonus mode under control of the processor in response to the occurrence of the award-credit outcome.

14. The method of claim 13 wherein:
each of the first plurality of possible bonus games has an associated bonus game paytable; and
the step of awarding credits is based on the bonus game paytable of the first bonus game.

15. The method of claim 13 further including each of the first plurality of possible bonus games is selected under control of the processor in the first bonus mode with equal frequency.

16. The method of claim 13 wherein each of the first plurality of possible bonus games is selected a second time only after all of the first plurality of possible bonus games have been selected once.

17. The method of claim 16 wherein the first bonus game is selected randomly.

18. The method of claim 16 wherein the first bonus game is selected linearly, such that each of the first plurality of possible bonus games is selected in a predetermined order.

19. The method of claim 13 wherein:
the processor is further operable in a second bonus mode;
the possible base game outcomes further include a second start-bonus outcome the occurrence of which causes the processor to shift from operating in the basic mode to operating in the second bonus mode;
a second bonus game is selected in the second bonus mode under control of the processor from among a second plurality of possible bonus games; and
the bonus game outcome is generated in the second bonus mode under control of the processor in the second bonus game.

20. The method of claim 19 wherein each of the second plurality of possible bonus games is selected a second time only after all of the second plurality of possible bonus games have been selected once.

21. The method of claim 20 wherein the second bonus game is selected randomly.

22. The method of claim 20 wherein the second bonus game is selected linearly, such that each of the second plurality of possible bonus games is selected in a predetermined order.
